(19) United States
(12) Patent Application Publication
(10) Pub. No.: US 2002/0070288 A1
(43) Pub. Date: Jun. 13, 2002

(54) Mixer bushing to improve melt homogeneity in injection molding machines and hot runners

(76) Inventor: Abdeslam Bouti, Swanton, VT (US)

Correspondence Address: PATENT ADMINSTRATOR, KATTEN MUCHIN ZAVIS, SUITE 1600, 525 WEST MONROE STREET, CHICAGO, IL, 60661, US

(21) Appl. No.: 09/983,028

(22) Filed: Oct. 22, 2001

Related U.S. Application Data
(63) Continuation-in-part of application No. 09/605,763, filed on Jun. 28, 2000.
Application No. 09/605,763 is a continuation-in-part of application No. 09/435,965, filed on Nov. 8, 1999.

(51) Int. Cl. B05B 1/24

(52) U.S. Cl. 239/135

(57) ABSTRACT

In an injection molding machine a mixer is provided that reduces the flow imbalances inherent in the melt. The mixer increase melt homogeneity by gradually mixing and changing the melt flow from all helical flow to all annular flow. The mixer provides an improved means for reducing flow imbalances that results in the elimination of weld lines and other part non-uniformities.

### CROSS-REFERENCE TO RELATED APPLICATIONS

This a Continuation-In-Part of co-pending application Ser. No. 09/605,763 filed Jun. 28, 2000 which is a Continuation-In-Part of U.S. patent application Ser. No. 09/435,965 filed Nov. 8, 1999, now U.S. Pat. No. 6,089,468, each of which are incorporated herein by reference.

### BACKGROUND OF THE INVENTION

The present invention relates to a mixer in an injection molding machine. More particularly, the present invention relates to a mixer bushing apparatus and method to improve the homogeneity of molten material in an injection molding machine and hot runners.

The large number of variables in the injection molding process creates serious challenges to creating a uniform and high quality part. These variables are significantly compounded within multi-cavity molds. Here we have the problem of not only shot-to-shot variations but also variations existing between individual cavities within a given shot. Shear induced flow imbalances occur in all multi-cavity molds that use the industry standard multiple cavity “naturally balanced” runner system whereby the shear and thermal history within each mold is thought to be kept equal regardless of which hot-runner path is taken by the molten material as it flows to the mold cavities. These flow imbalances have been found to be significant and may be the largest contributor to product variation in multi-cavity molds.

Despite the geometrical balance, in what has traditionally been referred to as “naturally balanced” runner systems, it has been found that these runner systems can induce a significant variation in the melt conditions delivered to the various cavities within a multi-cavity mold. These variations can include melt temperature, pressure, and material properties. Within a multi-cavity mold, this will result in variations in the size, shape, and mechanical properties of the product. Though the effect is most recognized in molds with eight or more cavities, it can create cavity to cavity variations in molds with as few as two cavities.

The flow imbalance in a mold with a geometrically balanced runner is created as a result of shear and thermal variations developed across the melt as it flows through the runner. The melt in the outer region (perimeter) of the runner's cross-section experiences different shear and temperature conditions than the melt in the center region. As flow is laminar during injection molding, the position of these variations across the melt stream is maintained along the length of the runner branch. When the runner branch is split, the center to perimeter variation becomes a side to side variation after the split. This side to side variation will result in variations in melt conditions from one side to the other of the part molded from the runner branch. If the runner branches were to split even further, as in a mold with 4 or more cavities, there will exist a different melt in each of the runner branches. This will result in variations in the product created in each mold cavity. It is important to note that as consecutive turns and/or splits of the melt channel occur, the difference in melt temperature and shear history is further amplified. This cumulative effect is clearly recognized in large multi-cavity molds where the runner branches split and turn many times.

It has also been discovered that melt imbalances can be created as far upstream of the injection process as the injection unit nozzle. In a typical injection molding machine, small pellets of plastic or like material are gravity-fed from a hopper to a reciprocating helical screw. As the helical screw is turned, the pellets are melted and forced to the front of the helical screw, where they are collected in a pool to be injected under high pressure into the runner system and the mold. Significant variations in melt properties can exist as the molten material exits the injection nozzle. Mixers have been developed for placement adjacent the injection unit nozzle, but these mixers are prone to failure due to the large injection pressures and are quite expensive to replace. In the event of a mixer failure, damage to the runner system and the mold is likely. Such damage requires expensive repair and significant machine down time.

In an attempt to reduce melt stream variations, the prior art has been directed at various mixing devices that are located along the melt path which is typically just prior the mold cavity, i.e. in the hot runner nozzle adjacent the mold cavity.

U.S. Pat. No. 5,405,258 to Babin (incorporated herein by reference) shows a hot runner nozzle having a torpedo which is used to conduct heat absorbed from the upstream melt along its length to the gate area. The torpedo is positioned within the melt stream and supported by spiral blades that induce a swirling motion to the melt as it flows past them.

U.S. Pat. No. 5,849,343 to Gellert et al. (incorporated herein by reference) shows a valve gated nozzle having a stem guiding nozzle tip that causes the melt to divide from a cylindrical flow to annular flow as it flows by the valve stem.

U.S. Pat. No. 4,965,028 to Manus et al., U.S. Pat. No. 5,513,976 to McGrevy, European Patent 0 546 554 to Gellert, and German Patent DE 32 01 710 to Gellert (each incorporated herein by reference) all teach various ways to mix the melt in a hot runner nozzle.

U.S. Pat. No. 5,545,028 to Hume et al. (incorporated herein by reference) shows a hot runner tip having a semi-torpedo style in which the outer surface of the torpedo includes a flow channel that converts a single cylindrical inlet flow to an annular flow passing by the tip.

In spiral mandrel dies used in extrusion molding, single or multiple incoming cylindrical melt streams can be converted to a single annular outflowing stream in a continuous process like blown film extrusion molding. U.S. Pat. Nos. 5,783,234 and 5,900,200 to Teng, (each incorporated herein by reference) show one application of this in a hot runner valve gated nozzle in which the spiral elements are formed in a comparatively large diameter valve stem and positioned relatively distant from the mold cavity.

U.S. Pat. No. 5,683,731 to Deardurff et al. (incorporated herein by reference) shows a melt flow redistributor. This device is an annular plug that is inserted at the intersection of branching hot runner channels. A first diverter is included for distributing the outside boundary later of the melt into a plurality of hot runner branches. A second diverter is included that distributes the center boundary layer of the melt into a plurality of hot runner branches for mixture with the outside boundary layer. In operation, this device acts more as a flow flipper than a mixer, with very little mixing and melt homogenizing occurring.

Efficient mixing of a molten material requires the occurrence of three separate actions. First, the molten material must be split and recombined. Second, the melt must be deformed by shear or extensional action. Lastly, the molten material must be reoriented. The sequence of these three separate actions is not important, as long as the three occur in a sequence configured to increase the mixing of the molten material. Performing these actions multiple times further enhances mixing of the molten material.

Accordingly, none of the prior art discloses an apparatus for reducing the variation within a melt flow as it exits the injection nozzle near the reciprocating screw or in the sprue bar without causing significant pressure drop. The prior art primarily attempts to reduce the variations within the melt by altering the flow of the melt within the hot runner nozzle. However, by the time the melt reaches the nozzle, there exists a large variation in the melt due to the cumulative effects of the flow imbalance. Indeed, the efficiency of the prior art will benefit from the use of the present invention because the melt that reaches the mixers located downstream near the hot runner nozzle, will have less variations in thermal and shear properties, thereby reducing the amount of mixing required by the mixing device located downstream and thereby improving overall part quality.

There exists a need, therefore, for an apparatus and method for use in injection molding machines that will reduce the cumulative effects of flow imbalance as it exits the injection unit nozzle and/or the sprue bar or bushing, thereby reducing the variations that occur in the finished product of a multi-cavity system.

### SUMMARY OF THE INVENTION

In a first aspect of the present invention, a mixer in an injection molding machine is provided comprising a first spiral bushing having a first spiral groove formed therein, the spiral groove having a first inlet for receipt of molten material and a first outlet for the exit of the molten material, the first spiral groove having first lands formed therebetween with the first spiral groove decreasing in depth towards the first outlet. A second spiral bushing in fluid communication with the first spiral bushing, the second spiral bushing having a second spiral groove formed therein, the second spiral groove having a second inlet in fluid communication with the first outlet, and a second outlet for the exit of the molten material, the second spiral groove having second lands formed therebetween, the second spiral groove decreasing in depth towards the second outlet. It is preferable the second spiral groove travels in a direction (clockwise or counterclockwise) opposite to the direction of the first spiral groove. An elongated torpedo disposed co-axial to the first spiral bushing and the second spiral bushing thereby forming a flow channel through said mixer. An annular ring disposed intermediate the first spiral bushing and the second spiral bushing, coupled to the elongated torpedo by at least one spoke protruding radially from a surface of the elongated torpedo, at a predetermined angle relative to a longitudinal axis of the torpedo, to a surface of the annular ring. In this arrangement, a helical flow path for the molten material is provided through the first and second spiral grooves and an axial flow path for the molten material is provided over the first and second lands.

In accordance with another aspect in accordance with the present invention, an injection molding method which comprises the steps of supplying molten material to a flow channel having an inner surface thereof, the flow channel extends in an injection unit of a molding machine from an inlet area for receipt of the molten material to an outlet area for exiting the molten material. An elongated torpedo substantially co-axial to the flow channel adjacent the outlet area is provided thereby transferring the molten material to a first spiral bushing having a first spiral groove formed therein, with first lands adjacent the first spiral groove and transferring the molten material from the first spiral bushing to a second spiral bushing having a second spiral groove formed therein with second lands adjacent the second spiral groove, and decreasing the depth of the first spiral groove and second spiral groove towards the outlet area and increasing the clearance of the first lands and second lands towards the outlet area, thereby flowing the molten material in a helical flow path through each the spiral groove and in an axial flow path over each the lands.

Yet another general aspect of the present invention is provided by an injection molding machine supplying molten material to a mold cavity through a first manifold, the first manifold in fluid communication with a plurality of hot runner manifolds, a mixer comprising a spiral bushing, having an inlet and an outlet and having a spiral groove formed therein, the spiral groove running from the inlet to the outlet and the bushing sealingly inserted in a bore of the bridge manifold. The inlet receiving the molten material from a first channel in the bridge manifold and the outlet transferring the molten material to a second channel in the hot runner manifold. An elongated torpedo disposed co-axial to the spiral bushing. In this arrangement, a helical flow path of the molten material is provided through the spiral groove and an axial flow path of molten material is provided over the lands.

Further aspects of the present invention will appear hereinbelow.

### BRIEF DESCRIPTION OF THE DRAWINGS

The present invention will be more readily understandable from a consideration of the accompanying illustrative drawings, wherein:

FIG. 1 is a sectional view of an exemplicative embodiment of the present invention;

FIG. 1a is a plan view of an exemplicative embodiment of the present invention;

FIG. 1b is a sectional view of the section A-A from FIG. 1a.

FIG. 2 is a partial sectional view of a further embodiment of the present invention in a sprue bar;

FIG. 3 is a sectional view of a further embodiment of the present invention;

FIG. 3a is a plan view of a bridge runner connected to two hot runner manifolds.

### DETAILED DESCRIPTION OF PREFERRED EMBODIMENTS

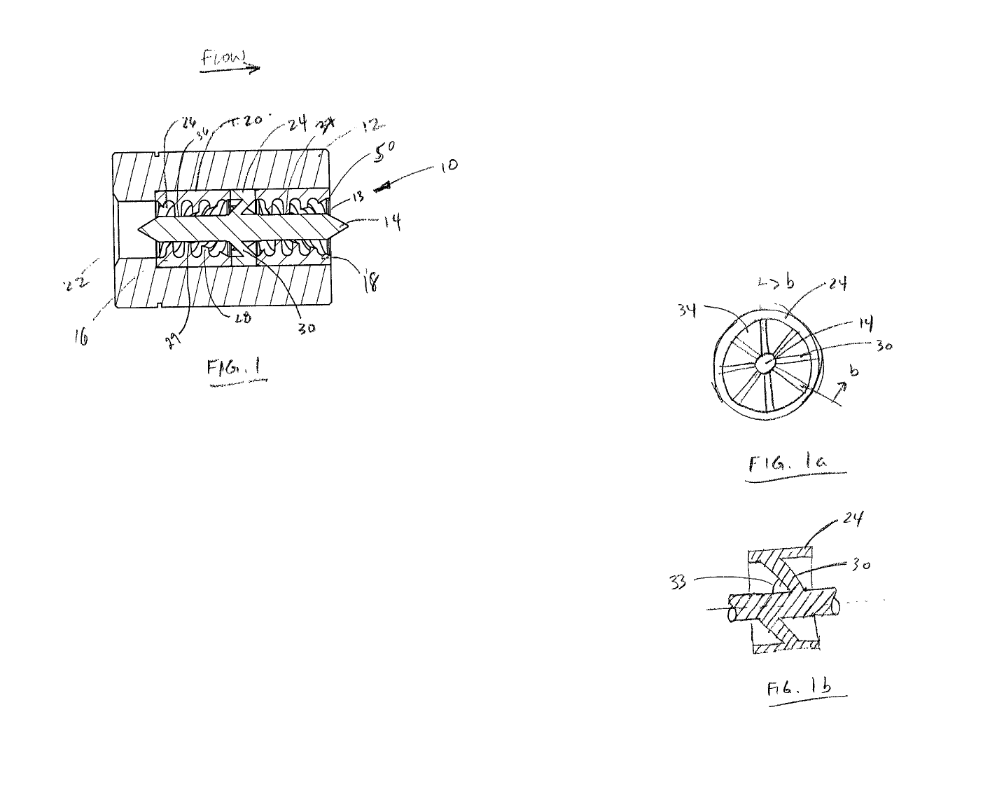

Referring to FIG. 1, a first preferred embodiment in accordance with the present invention is generally shown. This embodiment is comprised of four separate pieces that are assembled together for communication with, for example, a sprue bar/bushing or an injection unit of an injection molding machine. Sealingly inserted into a housing bore 20 of a flow channel housing 12 is a first spiral bushing 16 adjacent a flow inlet 22. An elongated torpedo or shaft 14 is inserted co-axially in the first spiral bushing 16. An annular ring 24 is affixed to the torpedo 14 by a plurality of radially spaced apart spokes 30 such that it seats on a face of the first spiral bushing 16. A second spiral bushing 18 is sealingly inserted in the housing bore 22 against the ring 24 adjacent a flow outlet 13. The torpedo 14 is co-axially located in the second spiral bushing 18.

At least one first spiral groove 26 is formed in an inside wall of the first spiral bushing 16. The outer surface of the torpedo 14 is preferably cylindrical. In addition, the first spiral groove 26 faces the torpedo 14 such that molten material will flow therebetween. The dimensions of the various components of the mixer will vary in accordance with the size of the melt channel which for example, can vary between 5 mm to 52 mm in diameter.

One or more lands 28 are provided adjacent the spiral groove 26. The groove is preferably formed so that it decreases in depth towards the ring 24. Lands 28 can be bonded to the torpedo 14 at a first bond area 36 adjacent the flow inlet 22. In a preferred embodiment, the torpedo 14 is press fit to the lands 28 to form the bond. Alternate arrangements could include threads, welding, brazing and the like. The lands 28 present an initial clearance 29 and increase in clearance with respect to the torpedo 14 towards the ring 24. The initial clearance 29 is an optional feature and is preferably at least 0.05 mm. Although larger or smaller clearances, for example 0.01 mm. to 1 mm., could be advantageous depending on the injection molding machine and the molten material to be processed. This initial clearance is advantageous for color change performance because it enables the flushing of any resin that may hang-up in the dead spots that occur between the spiral grooves. Otherwise, the resin will tend to fill part of the small initial clearance and hang-up there for a longer period of time making color changes very lengthy. Also, the resin may hang-up there until it degrades and bleeds back into the melt stream. However, by providing an initial clearance of at least 0.05 mm this abrupt, definite clearance at the end of the contact between the lands and the shaft enables part of the melt stream to flow in the circumference between the grooves to clean out the dead spots.

A second spiral groove 27 is formed in an inside wall of the second spiral bushing 18. In addition, the second spiral groove 27 faces the torpedo 14 such that molten material will flow therebetween.

One or more lands 28 are also provided adjacent the spiral groove 27. The groove 27 is preferably formed so that it decreases in depth towards the flow outlet 13. In a preferred embodiment, the groove depth starts out to be about 1.5 times the groove diameter and decreases linearly. Alternate arrangements could have the groove decreasing in depth geometrically or some other non-linear rate. Lands 28 can be bonded to torpedo 14 at second bond area 37 by any known means. The lands 28 present an initial clearance and increase in clearance with respect to torpedo 14 towards the flow outlet 13.

While the foregoing description has mentioned the use of a cylindrical torpedo and mating mixer bushings, one of ordinary skill in the art will realize a myriad of appropriate shapes can be fashioned to perform the function of the present invention. For example, the torpedo could be conical, the spiral groove cross-section could be square, the spiral grooves could be constant or variable pitch, etc. All such modifications are fully contemplated by the present invention.

Referring now to FIGS. 1a and 1b, the structure of the ring 24 will now be described in more detail. Protruding radially from torpedo 14 is at least one spoke 30 preferably to affix annular ring 24 to the torpedo 14. A plurality of flow areas 34 are provided between the successive spokes 30 to allow for the flow of the melt therethrough. As shown in FIG. 1b, the angle 33 of the spoke varies in relation to a longitudinal axis of the torpedo. In a preferred embodiment, the spoke 30 is at either an acute or obtuse angle such that it reduces the formation of stagnation points as the flowing melt strikes the face of the spoke 30. It has been found that an angle of about 45 degrees or about 135 degrees provides the best results. It has been found that the angle 33 between successive spokes 30 can be altered between being acute to obtuse with respect to the longitudinal axis of the torpedo 14. This allows the placement of additional spokes 30 without unreasonably restricting the flow of the molten material.

In operation therefore, the melt flows from the inlet end 22 of the housing 12 towards the outlet end 13. The melt enters one or more of the first spiral grooves 26. The spiral grooves induce a helical clockwise or counterclockwise flow path to the melt. As the melt progresses towards the ring 24, progressively more and more of the melt spills over the lands 28 as the lands increase in clearance and as the groove depth decreases so that the helical flow direction is gradually transformed to an axial flow direction over the length of the first spiral bushing 16. At the end of the spiral groove section, the melt passes through the flow area 34 around the spokes 30. The spokes 30 split and recombine the melt to further increase melt mixing.

The melt then enters the second spiral groove 27 formed in the second spiral bushing 18. Again, the spiral grooves induce a helical clockwise or counterclockwise flow path to the melt, preferably opposite to the direction of the first helical groove. As the melt progresses towards the flow outlet 13, progressively more and more of the melt spills over the lands 28 as the lands increase in clearance from the torpedo and as the groove depth decreases so that the helical flow direction is gradually transformed to an axial flow direction over the length of the second spiral bushing 18. At the end of the spiral groove section, the melt passes through an annular section 50 of the second spiral bushing 18 downstream of the second groove 27 which is comparatively large in diameter. Accordingly, the melt stream is relaxed as it flows through the annular section 50. The relaxation section helps to minimize stresses and any flow irregularities and further homogenize the melt. Finally, the melt exits from the flow housing 12, where the melt could be further split.

The mixer design of the present invention can be defined by the following four zones:

A bond area between the lands and the shaft may feature a tapered seat that locks the torpedo to resist pressure action. This bond area provides the support and/or alignment for the torpedo. This bond area could also be configured to allow for a sliding valve stem, wherein the valve stem acts as the torpedo 14.

A zone of a finite initial gap or initial clearance that comprises an abrupt elimination of the contact between the lands and the torpedo. This feature prevents resin hang-up that may occur when the clearance increase starts from zero. This initial gap allows part of the melt to flow around and clean the dead spots generated between the grooves at the beginning of the clearance increase. The initial clearance value depends on the material processed and the process parameters (flow rate, melt channel diameter, etc.).

A zone of flow conversion where the melt stream is converted gradually from a helical flow into an annular flow without creating weld lines that will appear in the molded part. In this zone the depth of the grooves decrease gradually and the gap between the shaft and the lands increase gradually.

A relaxation zone that enables the molten material molecules to relax from the stresses that accumulated during the flow conversion in the previous zone. The relaxation zone can be used as well as a run-out for manufacturing tools.

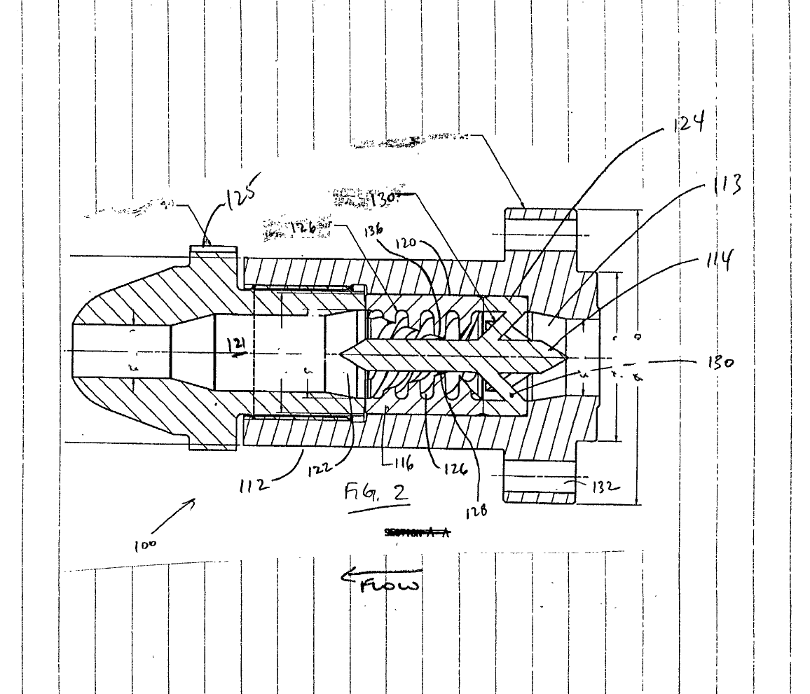

Referring now to FIG. 2, another preferred embodiment 100 in accordance with the present invention is generally shown. In this embodiment, a mixer is provided in a machine nozzle assembly. A spiral bushing 116 having a spiral groove 126 formed therein is inserted in a front portion 120 of a flow channel 121 located in, for example, a machine nozzle adapter 112, for the communication of a melt to a mold cavity (not shown). An elongated torpedo 114 having an annular ring 124 affixed thereto is inserted co-axially to and seats against a face of the spiral bushing 116.

Spiral groove 126 is formed in an inside wall of the spiral bushing 116. The outer surface of the torpedo 114 is preferably cylindrical. The exposed surface of the spiral bushing 116 includes at least one spiral groove 126. In addition, the first spiral groove 126 faces the torpedo 114 to form a helical flow channel therebetween.

Lands 128 are provided adjacent the spiral groove 126. The groove is preferably formed so that it decreases in depth towards the ring 124. The lands 128 are bonded to the torpedo 114 at the bond area 136 adjacent the flow inlet 122. The lands 128 present an initial clearance and increase in clearance with respect to the torpedo 114 towards the ring 124. The initial clearance is an optional feature and is preferably at least 0.05 mm. As mentioned previously, this initial clearance is advantageous for color change performance because it enables the flushing of any resin that may hang-up in the dead spots that occur between the spiral grooves. Otherwise, the resin will tend to fill part of the small initial clearance and hang-up there for a longer period of time making color changes very lengthy. Also, the resin may hang-up there until it degrades and bleeds back into the melt stream. However, by providing an initial clearance of at least 0.05 mm this abrupt, definite clearance at the end of the contact between the lands and the shaft enables part of the melt stream to flow in the circumference between the grooves to clean out the dead spots.

Preferably protruding radially from the torpedo 114 is a plurality of spokes 130 to affix the annular ring 124 to the torpedo 114. A flow area as shown in FIG. 1a is provided between each successive spoke 130 to allow for the flow of the melt therethrough. As shown in FIG. 1b, the angle 33 of the spoke 130 varies in relation to the longitudinal axis of the torpedo 114. In a preferred embodiment, the spoke 130 is at either an acute or obtuse angle such that it reduces pressure drop and the formation of stagnation points as the flowing melt strikes the face of the spoke 130. It has been found that an angle of about 45 degrees or about 135 degrees provides the best results.

An injection machine nozzle tip 125, with a shape well known in the art, is received in the assembly 100 preferably affixing the spiral bushing and torpedo in the assembly.

In operation therefore, the melt flows from the inlet end 113 towards the outlet end 122The melt enters one or more of the spiral grooves 126. The spiral grooves induce a helical flow path to the melt. As the melt progresses towards the outlet end 122, progressively more and more of the melt spills over the lands 128 as the lands increase in clearance and as the groove depth decreases so that the helical flow direction is gradually transformed to an axial flow direction over the length of the spiral bushing 116. Adjacent the inlet end 113, the melt passes through the flow area around the spokes 130. The spokes 130 split and recombine the melt to further increase melt homogeneity.

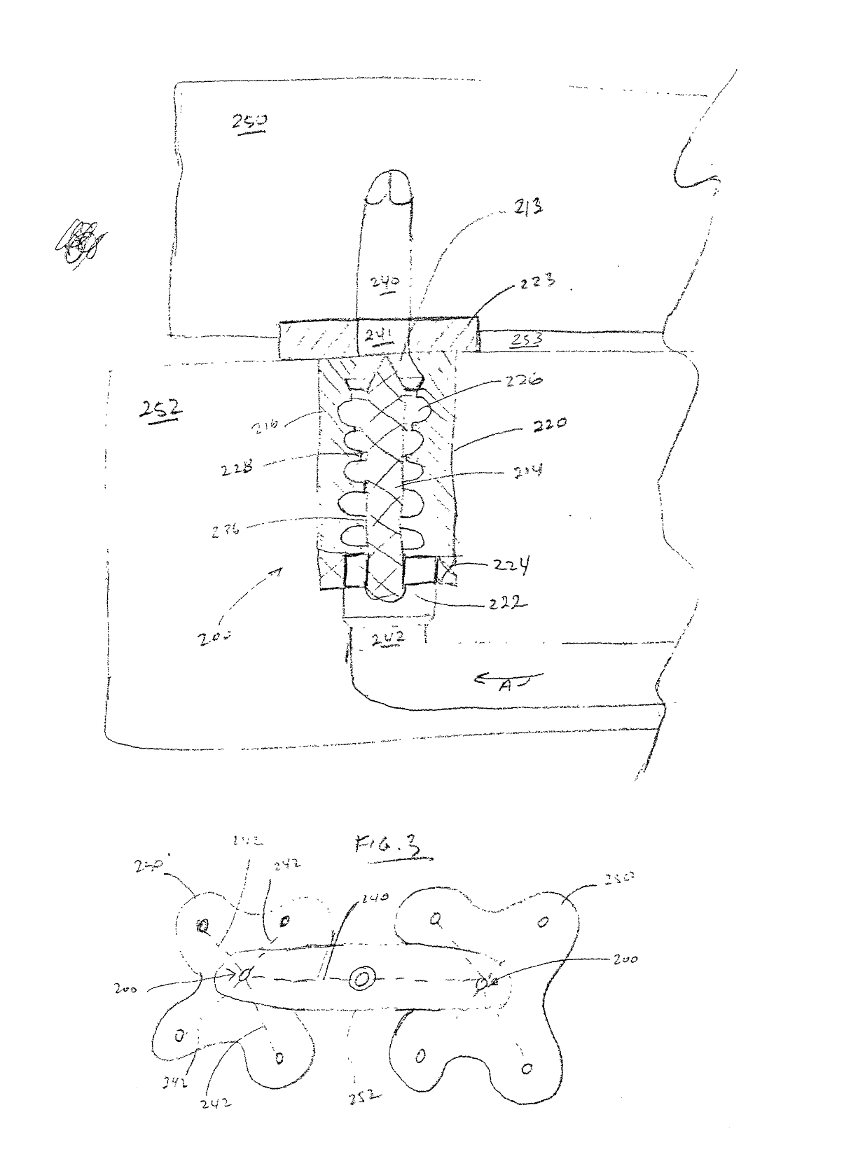

Referring now to FIGS. 3 and 3a, another alternative embodiment 200 in accordance with the present invention is shown. In this embodiment, a spiral bushing 216 with a spiral groove 226 formed therein is inserted in a bore 220 of a bridge manifold 252 in alignment with a first channel 240 located in, for example, a hot runner manifold 250. A disc 223 is located between the bridge manifold 252 and the hot runner manifold 250. A passageway 241 is provided in the disc 223 to allow for the communication of the melt therethrough.

An elongated torpedo 214 is inserted co-axially in the spiral bushing 216. A ring 224 adjacent a flow inlet 222 is affixed to the torpedo 214 by a plurality of spokes similar to the previous embodiments.

At least one spiral groove 226 is formed in an inside wall of the spiral bushing 216. The outer surface of the torpedo 214 is preferably substantially cylindrical. In addition, the first spiral groove 226 faces torpedo 214 to form a helical flow channel therebetween.

Similar to the previous embodiments, the lands 228 are provided adjacent the spiral groove 226. The groove is formed so that it decreases in depth towards the disc 223. Lands 228 are bonded to the torpedo 214 at the bond area 236 adjacent the flow inlet 222. The lands 228 present an initial clearance and increase in clearance with respect to torpedo 214 towards the disc 223. The initial clearance is an optional feature and is preferably at least 0.05 mm.

In operation therefore, the melt flows from the channel 242 to the inlet 222 towards the outlet end 213. The melt enters one or more of the spiral grooves 226. The spiral grooves induce a helical flow path to the melt. As the melt progresses towards the disc 223, progressively more and more of the melt spills over the lands 128 as the lands increase in clearance and as the groove depth decreases so that the helical flow direction is gradually transformed to an axial flow direction over the length of spiral bushing 216.

It is to be understood that the invention is not limited to the illustrations described and shown herein, which are deemed to be merely illustrative of the best modes of carrying out the invention, and which are susceptible to modification of form, size, arrangement of parts and details of operation. The invention rather is intended to encompass all such modifications which are within its spirit and scope as defined by the appended claims.

What is claimed is:

1. An injection molding machine mixer comprising:
a first spiral bushing having a first spiral groove formed therein, said first spiral groove having a first inlet for receipt of molten material and a first outlet for the exit of said molten material, said first spiral groove having a first land formed therein, said first spiral groove decreasing in depth from said first inlet to said first outlet;
a second spiral bushing having a second spiral groove formed therein, each second spiral groove having a second inlet in fluid communication with said first outlet, and a second outlet for the exit of said molten material, said second spiral groove having a second land formed therebetween, said second spiral groove decreasing in depth from said second inlet to said second outlet,
an elongated torpedo disposed co-axial to said first spiral bushing and said second spiral bushing, thereby forming a flow channel through said mixer,
an annular ring disposed intermediate said first spiral bushing and said second spiral bushing; and
a spoke protruding radially from a surface of said elongated torpedo, at a predetermined angle relative to a longitudinal axis of said torpedo, and coupled to said annular ring,
wherein a helical flow path for the molten material is provided through said first and second spiral grooves and an axial flow path for the molten material is provided over said first and second lands.

2. A mixer according to claim 1, wherein said predetermined angle is not equal to substantially 90 degrees with respect to the longitudinal axis of said torpedo.

3. A mixer according to claim 1, wherein said predetermined angle is one of substantially 45 degrees and substantially 135 degrees.

4. A mixer according to claim 1, wherein said mixer is disposed in a flow channel housing.

5. A mixer according to claim 4, wherein said flow channel housing is affixed adjacent an injection unit of said injection molding machine.

6. A mixer according to claim 1, wherein a portion of at least one of said first and second lands is bonded to said torpedo and wherein said first and second lands increase in clearance with respect to the torpedo from a respective inlet to a respective outlet.

7. A mixer according to claim 6, wherein an initial clearance to allow for molten material to flow therethrough of at least substantially 0.05 mm is provided proximate to where said torpedo is bonded to said lands.

8. A mixer according to claim 1, wherein said torpedo comprises a cylindrical shaft.

9. A mixer according to claim 1, wherein said first and second spiral grooves are configured to cause said helical flow to gradually change to an axial flow.

10. A mixer according to claim 1, wherein said first helical groove travels in either a clockwise or counterclockwise direction and said second helical groove travels in a direction opposite said direction of said first helical groove.

11. A mixer according to claim 1, wherein said torpedo is tapered at an end thereof.

12. A mixer according to claim 1, wherein said torpedo comprises two conical ends.

13. A mixer according to claim 1, wherein said mixer is disposed in a sprue bar/bushing.

14. A mixer according to claim 1, wherein said mixer is press fit in an injection unit of said injection molding machine.

15. A mixer according to claim 14, wherein said mixer is affixed to said injection unit by threads on one of said first spiral bushing, said second spiral bushing, and said torpedo.

16. An injection molding machine for the formation of a molded article, comprising:
an injection unit, having a rotating and reciprocating helical screw therein configured to inject molten material,
a set of separable mold halves forming a mold cavity therebetween, said mold cavity defining the shape of the molded article and configured to receive the molten material from said injection unit,
a mixer located in said injection molding machine for the reduction of flow imbalances in the molten material, said mixer comprising,
a first spiral bushing having a first spiral groove formed therein, said first spiral groove having a first inlet for receipt of molten material and a first outlet for the exit of said molten material, said first spiral groove having a first land formed therein, said first spiral groove decreasing in depth from said first inlet to said first outlet;
a second spiral bushing having a second spiral groove formed therein, each second spiral groove having a second inlet in fluid communication with said first outlet, and a second outlet for the exit of said molten material, said second spiral groove having a second land formed therebetween, said second spiral groove decreasing in depth from said second inlet to said second outlet,
an elongated torpedo disposed co-axial to said first spiral bushing and said second spiral bushing, thereby forming a flow channel through said mixer,
a spoke protruding radially from a surface of said elongated torpedo, at a predetermined angle relative to a longitudinal axis of said torpedo,
wherein a helical flow path for the molten material is provided through said first and second spiral grooves and an axial flow path for the molten material is provided over said first and second lands.

17. The injection molding machine of claim 16, wherein said mixer is installed in said injection unit.

18. The injection molding machine of claim 16, further comprising a sprue bar/bushing in fluid communication between said injection unit and said mold cavity.

19. The injection molding machine of claim 18, wherein said mixer is disposed in said sprue bar.

20. The injection molding machine of claim 18, wherein said mixer is disposed in a flow channel housing, and said flow channel housing is affixed to said sprue bar.

21. The injection molding machine of claim 16 wherein said elongated torpedo further comprises a ring affixed to said torpedo by a spoke extending radially from said torpedo to said ring.

22. The injection molding machine of claim 21, wherein said spoke extends from said torpedo to said ring at a predetermined angle in relation to said longitudinal axis of said elongated torpedo.

23. The injection molding machine of claim 22, wherein said predetermined angle is between about 95 and about 150 degrees from said longitudinal axis of said elongated torpedo.

24. The injection molding machine of claim 22, wherein said predetermined angle of successive said spokes alternates between an obtuse angle and an acute angle.

25. The injection molding machine of claim 21, wherein said ring is located between said first spiral bushing and said second spiral bushing.

26. The injection molding machine of claim 16, wherein a portion of said lands from at least one of said first and second spiral bushings are bonded to said torpedo and wherein said lands increase in clearance with respect to said torpedo towards said outlet.

27. The injection molding machine of claim 26, wherein an initial clearance of at least 0.05 mm is provided adjacent where said torpedo is bonded to said lands.

28. The injection molding machine of claim 16, wherein said torpedo is a cylindrical shaft.

29. The injection molding machine of claim 16, wherein said helical flow is gradually changed to an axial flow path.

30. The injection molding machine of claim 16, wherein said grooves are substantially circular.

31. The injection molding machine of claim 16, wherein said torpedo is tapered.

32. The injection molding machine of claim 16, wherein said torpedo is comprised of a movable valve stem to start and stop the flow of the molten material.

33. An injection molding method which comprises the steps of:
supplying molten material to a flow channel having an inner surface thereof, said flow channel extending in an injection unit of a molding machine from an inlet area for receipt of said molten material to an outlet area for transferring said molten material;
providing an elongated torpedo substantially co-axially positioned in said flow channel adjacent said outlet area;
transferring said molten material to a first spiral bushing having at least one first spiral groove formed therein, with first lands adjacent said first spiral groove and transferring said molten material from said first spiral bushing to a second spiral bushing having at least one second spiral groove formed therein with second lands adjacent said second spiral groove; and
decreasing the depth of at least one of said first spiral groove and second spiral groove towards the outlet area and increasing the clearance of at least one of said first lands and second lands towards the outlet area, thereby flowing said molten material in a helical flow path through each said spiral groove and in an axial flow path over each said lands.

34. A method according to claim 33, including the step of cutting said groove in said inner surface of said flow channel.

35. A method according to claim 33, including the step of providing a sleeve in the flow channel adjacent the elongated torpedo and forming at least one of said first and second grooves in said sleeve.

36. A method according to claim 33, including the step of bonding a portion of at least one of said first and second lands to said shaft and increasing the clearance to said lands with respect to said torpedo towards said outlet area.

37. A method according to claim 36, including the step of providing an initial clearance of at least 0.05 mm between said shaft and said first and second lands.

38. A method according to claim 33, including gradually changing said molten material flow from a helical flow to an axial flow path.

39. A method according to claim 33, including the step of forming at least one of said first and second grooves in said inner surface of said flow channel and in an outer surface of said torpedo.

40. In an injection molding machine supplying molten material to a mold cavity through a first manifold, said first manifold in fluid communication with a plurality of hot runner manifolds, a mixer comprising;
a spiral bushing, having an inlet and an outlet, said spiral bushing having a spiral groove formed therein, said spiral groove running from said inlet to said outlet, said spiral bushing inserted in a bore of said first manifold,
said inlet receiving the molten material from a first channel in said first manifold and said outlet transferring the molten material to a second channel in said hot runner manifold,
an elongated torpedo disposed co-axial to said spiral bushing,
wherein a helical flow path of the molten material is provided through said spiral groove and is gradually transitioned to an axial flow path over said lands.

41. A mixer according to claim 40, wherein said spiral groove is formed in said first manifold.

42. A mixer according to claim 40, wherein said elongated torpedo is further comprised of a ring coupled to said torpedo by a spoke extending radially from said torpedo to said ring.

43. A mixer according to claim 42, wherein said spoke extends from said torpedo to said ring at a predetermined angle in relation to a longitudinal axis of said elongated torpedo.

44. A mixer according to claim 43, wherein said predetermined angle is not substantially 90 degrees.

45. A mixer according to claim 43, wherein said predetermined angle is between about 95 and about 150 degrees.

46. A mixer according to claim 43, wherein said predetermined angle alternates from an obtuse angle to an acute angle.

47. A mixer according to claim 43, wherein said ring is located adjacent said flow inlet.

48. A mixer according to claim 40, wherein a portion of said lands are bonded to said torpedo and wherein said lands increase in clearance with respect to said torpedo towards said outlet.

49. A mixer according to claim 48, wherein an initial clearance of at least 0.05 mm is provided adjacent where said torpedo is bonded to said lands.

50. A mixer according to claim 40, wherein said torpedo comprises a cylindrical shaft.

51. A mixer according to claim 40, wherein the depth of said groove is decreases from said inlet to said outlet causing said helical flow to gradually change to an axial flow path.

52. A mixer according to claim 40, wherein said groove cross-section is one selected from the shapes consisting of circular, square, rectangular, triangular and trapezoidal.

53. A mixer according to claim 40, wherein said torpedo is tapered at an end thereof.

54. A mixer according to claim 40, wherein said torpedo is located upstream or downstream of said spiral bushing.

55. A mixer according to claim 40, wherein said mixer is press fit in said first manifold.

56. A mixer according to claim 40 further comprising a disc having a passageway therethrough, said disc inserted between said first manifold and said hot runner manifold.

57. A mixer according to claim 56 wherein said disc is seated in a bore in said hot runner manifold.

58. A mixer means for the reduction of flow imbalance in an injection molding machine, said mixer means comprising:
a first spiral bushing means for communication of a molten material, said first spiral bushing means having at least one first spiral groove formed therein each having a first inlet for receipt of molten material and a first outlet for the transfer of said molten material, each said first spiral groove having first lands formed therebetween, each said first spiral groove decreasing in depth towards said first outlet,
a second spiral bushing means for communication of said molten material, said second spiral bushing means having at least one second spiral groove formed therein, each having a second inlet in fluid communication with said first outlet, and a second outlet for the transfer of said molten material, each said second spiral groove having second lands formed therebetween, each said second spiral groove decreasing in depth towards said second outlet,
an elongated torpedo means for the communication of said molten material, said torpedo means inserted co-axially to and running substantially the length of said first spiral bushing means and said second spiral bushing means thereby forming a flow channel through said mixer,
an annular ring intermediate said first spiral bushing means and said second spiral bushing means, affixed to said elongated torpedo means by at least one spoke protruding radially from a surface of said elongated torpedo means, at a predetermined angle relative to the longitudinal axis of said torpedo means, to a surface of said annular ring,
wherein a helical flow path for the molten material is provided through said first and second spiral grooves and an axial flow path for the molten material is provided over said first and second lands.

59. A mixer means according to claim 58, wherein said predetermined angle is not equal to 90 degrees.

60. A mixer means according to claim 58, wherein said predetermined angle is one of 45 degrees and 135 degrees.

61. A mixer means according to claim 58, wherein said mixer means is inserted in a flow channel housing.

62. A mixer means according to claim 61, wherein said flow channel housing is affixed adjacent an injection unit of said injection molding machine.

63. A mixer means according to claim 58, wherein a portion of said lands from at least one of said first spiral bushing means and second spiral bushing means are bonded to said torpedo means and wherein the lands increase in clearance with respect to the torpedo means towards each said outlet.

64. A mixer means according to claim 63, wherein an initial clearance of at least 0.05 mm is provided adjacent where said torpedo means is bonded to said lands.

65. A mixer means according to claim 58, wherein said torpedo means is a comprised of a cylindrical shaft.

66. A mixer means according to claim 58, wherein said helical flow is gradually changed to an axial flow path.

67. A mixer means according to claim 58, wherein each said groove is substantially circular.

68. A mixer means according to claim 58, wherein said torpedo means is tapered.

69. A mixer means according to claim 58, wherein said torpedo means is further comprised of conical ends.

70. A mixer means according to claim 58, wherein said mixer means is installed in a sprue bar.

71. A mixer means according to claim 58, wherein said mixer means is press fit in an injection unit of said injection molding machine.

72. A mixer means according to claim 71, wherein said mixer means is affixed to said injection unit by threads on one of said first spiral bushing means, said second spiral bushing means and said torpedo means.

73. An injection molding machine mixer comprising:
a first spiral groove-land combination having a first inlet and a first outlet disposed in a melt channel of the injection molding machine;
a second spiral groove-land combination having a second inlet in fluid communication with said first outlet, and a second outlet;
a torpedo disposed inside of said first and second spiral groove-land combination configured to provide a gap between each land of said first and second spiral groove-land combination, said gap increasing from a respective said inlet to a respective said outlet; and
a spoke protruding in said melt channel at a predetermined angle with respect to a longitudinal axis of said torpedo.

74. A mixer according to claim 73 wherein said predetermined angle is not substantially equal to 90 degrees.

75. A mixer according to claim 73 wherein said spoke protrudes from said torpedo.

76. A mixer according to claim 75 further comprising an annular ring disposed in said melt channel and coupled to said spoke.

77. A mixer according to claim 76 wherein said annular ring is disposed between said first and second spiral groove-land combination.

78. An injection molding machine mixer comprising:
a first clockwise helical groove having a predetermined depth and a predetermined length disposed in a melt channel in the injection molding machine;
a second counterclockwise helical groove having a predetermined depth and a predetermined length disposed in said melt channel, said second helical groove in fluid communication with said first helical groove;
a shaft disposed in said first and second helical groove configured to provide a spiral flow path around said shaft and a longitudinal flow path along said shaft; and
a spoke protruding in said melt channel at a predetermined angle with respect to a longitudinal axis of said melt channel.

79. A mixer according to claim 78 wherein said predetermined depth of said grooves decreases in the direction of the melt flow.

80. A mixer according to claim 78 wherein said predetermined depth of said grooves increases in the direction of the melt flow.

81. A mixer according to claim 78 wherein said predetermined depth of said first spiral groove increases in the direction of melt flow and the predetermined depth of said second spiral groove decreases in the direction of melt flow.

82. A mixer according to claim 78 wherein said predetermined depth of said first spiral groove decreases in the direction of melt flow and the predetermined depth of said second spiral groove increases in the direction of melt flow.

83. A mixer according to claim 78 wherein said predetermined angle is not equal to about 90 degrees.

84. A mixer according to claim 78, wherein said mixer is disposed in at least one location selected from the group consisting of an injection unit nozzle, a sprue bar, a sprue bushing, a bridge manifold, a hot runner manifold, a hot runner nozzle, an injection nozzle bushing and a mixer plate disposed just prior a mold of the injection molding machine.
